(19) United States
(12) Patent Application Publication
(10) Pub. No.: US 2023/0382162 A1
(43) Pub. Date: Nov. 30, 2023

(54) TIRE

(71) Applicant: Sumitomo Rubber Industries, Ltd., Kobe-shi (JP)

(72) Inventors: Hiroshi KIKUCHI, Kobe-shi (JP); Masahiro NAGASE, Kobe-shi (JP); Shouta MAKINO, Kobe-shi (JP)

(73) Assignee: Sumitomo Rubber Industries, Ltd., Kobe-shi (JP)

(21) Appl. No.: 18/200,586

(22) Filed: May 23, 2023

(30) Foreign Application Priority Data
May 25, 2022 (JP) 2022-085080

(51) Int. Cl. B60C 3/04; B60C 11/00; B60C 11/01; B60C 11/03

(52) U.S. Cl. CPC B60C 3/04; B60C 11/0083; B60C 11/01; B60C 11/0332

(57) ABSTRACT

An outer surface of a tire can include a tread surface and a pair of side surfaces. A contour line of the tread surface can include a center arc, a pair of middle arcs, a pair of side arcs, and a pair of shoulder arcs. A contour line of each side surface can be connected to the shoulder arc. A position, on the outer surface, corresponding to a ground-contact end obtained by applying a load that is 80% of a standardized load, to the tire in a standardized state, and bringing the tire into contact with a flat surface is a reference ground-contact position, and a boundary between the shoulder arc and the side arc is a reference boundary. The reference boundary can be located axially outward of the reference ground-contact position. A ratio of a distance in an axial direction from an equator plane to the reference boundary to a distance in the axial direction from the equator plane to a tread reference end TE can be not less than 0.94 and not greater than 0.98.

### CROSS-REFERENCE TO RELATED APPLICATION(S)

The present application claims priority to Japanese patent application JP 2022-085080, filed on May 25, 2022, the entire contents of which is incorporated herein by reference in its entirety.

### BACKGROUND

### Technical Field

The present disclosure relates to a tire. Specifically, the present disclosure relates to a tire that is mounted to a passenger car.

### Background Art

From consideration for the environment, reduction of rolling resistance may be required for tires that are mounted to vehicles. Therefore, for example, decreasing the number of components included in a tire, decreasing the thicknesses of the components, using materials having low energy loss, specifically, rubbers having a low loss tangent (hereinafter, referred to as low loss rubbers), as the materials forming the components, etc., are considered (for example, Japanese Laid-Open Patent Publication No. 2021-120242).

The tread of a tire can include a cap portion and a base portion. The cap portion comes into contact with a road surface. For the cap portion, a rubber for which grip performance and wear resistance are taken into consideration is used. The base portion is covered with the cap portion and does not come into contact with a road surface. For the base portion, a low loss rubber is used.

By using the low loss rubber for the cap portion, the rolling resistance of the tire can be reduced further. However, if a low loss rubber is used for the cap portion, there is a concern about a decrease in grip performance on a wet road surface. Establishment of a technology capable of achieving reduction of rolling resistance without using a low loss rubber for the cap portion may be required.

### SUMMARY

A tire according to one or more embodiments of the present disclosure can include: a pair of beads; a carcass extending on and between the pair of beads; a pair of sidewalls located axially outward of the carcass; a tread located radially outward of the carcass; and a belt located between the carcass and the tread. An outer surface of the tire can include a tread surface configured to come into contact with a road surface, and a pair of side surfaces connected to the tread surface. The tread surface can include an equator that is a point of intersection with an equator plane. Each of the side surfaces can include a maximum width position at which the tire has a maximum width. In a meridian cross-section of the tire, a contour line of the tread surface can include a plurality of arcs aligned in an axial direction. The plurality of arcs can include a center arc passing through the equator, a pair of middle arcs connected to the center arc, a pair of side arcs connected to the middle arcs, respectively, and a pair of shoulder arcs connected to the side arcs, respectively. Contour lines of the pair of side surfaces can be connected to the pair of shoulder arcs, respectively. A point of intersection of a tangent line tangent to the shoulder arc at a first end of the shoulder arc and a tangent line tangent to the shoulder arc at a second end of the shoulder arc can be regarded as a tread reference end. A ground-contact end obtained by fitting the tire onto a standardized rim, adjusting an internal pressure of the tire to a standardized internal pressure, applying a load that is 80% of a standardized load, to the tire, and bringing the tire into contact with a flat surface can be regarded as a reference ground-contact end. A position, on the outer surface of the tire, corresponding to the reference ground-contact end can be regarded as a reference ground-contact position, and a boundary between the shoulder arc and the side arc can be regarded as a reference boundary. The reference boundary can be located axially outward of the reference ground-contact position. A ratio of a distance in the axial direction from the equator plane to the reference boundary to a distance in the axial direction from the equator plane to the tread reference end can be not less than 0.94 and not greater than 0.98.

### BRIEF DESCRIPTION OF THE DRAWINGS

FIG. 1 is a cross-sectional view showing a part of a tire according to an embodiment of the present disclosure;

FIG. 2 is a cross-sectional view illustrating a contour line of a tread surface;

FIG. 3 is a schematic diagram showing a ground-contact surface shape of the tire;

FIG. 4 is a cross-sectional view illustrating a positional relationship between a reference boundary and a reference ground-contact end;

FIG. 5 is a cross-sectional view illustrating a contour line of a conventional tread surface; and

FIG. 6 is a schematic diagram illustrating deformation of a tread portion due to contact with a road surface.

### DETAILED DESCRIPTION

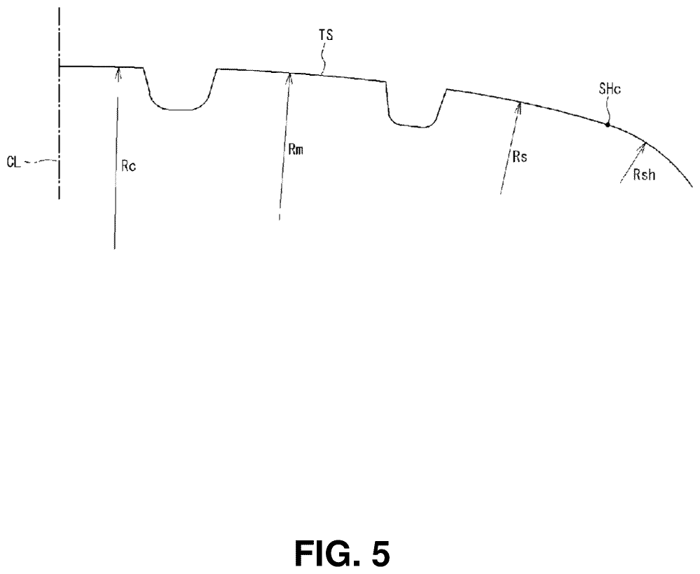

FIG. 5 shows a contour line of a tread surface TS in a meridian cross-section of a conventional tread surface. The contour line of the tread surface TS can be formed by combining a plurality of arcs in an axial direction. The arcs forming the contour line shown in FIG. 5 include a center arc, a middle arc, a side arc, and a shoulder arc from an equator plane CL toward the axially outer side. The center arc has a largest radius Rc. The middle arc has a next largest radius Rm. The side arc has a next largest radius Rs. The shoulder arc has a smallest radius Rsh. A contour line of a side surface can be connected to the shoulder arc.

In the contour line of the tread surface TS, the radius of curvature changes at the boundaries between the adjacent arcs. In the contour line of the tread surface TS, the boundary at which the rate of change of the radius of curvature is the largest is the boundary between the side arc and the shoulder arc (hereinafter, referred to as reference boundary SHc).

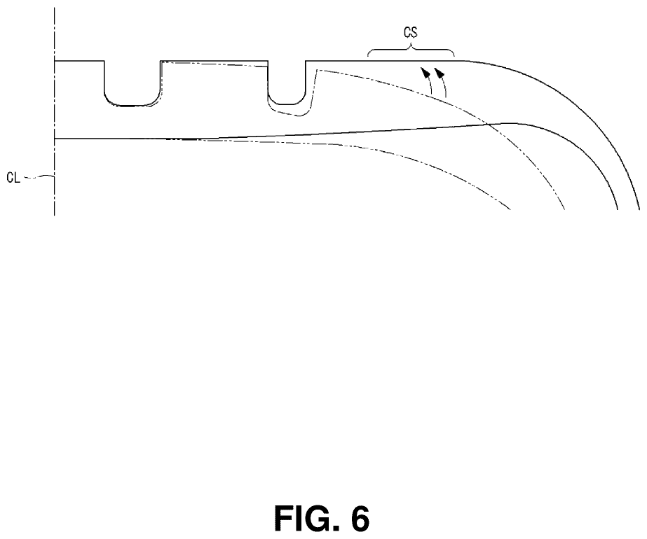

In FIG. 6, a solid line schematically shows the state of a tread portion that is in contact with a road surface. An alternate long and two short dashes line shows the state of the tread portion before (or after) the tread portion comes into contact with a road surface.

As shown in FIG. 6, the tread portion becomes significantly deformed at a shoulder portion thereof when the tread portion comes into contact with the road surface. Accordingly, compressive strain is generated at a surface layer portion, of the shoulder portion, indicated by reference character CS. The compressive strain can be a factor that increases rolling resistance. If generation of compressive strain can be suppressed, it is expected that rolling resistance can be reduced further.

The contour line of a tread surface may be closely related to the state of contact between a tread and a road surface. Therefore, the present inventors have conducted a thorough study for the relationship between the contour line of the tread surface and generation of compressive strain. As a result, the present inventors have found that the position of a reference boundary with respect to a ground-contact end can be involved in generation of compressive strain, and thus have completed the present disclosure.

Hereinafter, the present disclosure will be described in detail based on preferred embodiments with appropriate reference to the drawings.

According to one or more embodiments of the present disclosure, a tire that can achieve reduction of rolling resistance without decreasing grip performance on a wet road surface can be obtained.

A tire of the present disclosure can be fitted on a rim. The interior of the tire can be filled with air to adjust the internal pressure of the tire. In the present disclosure, the tire fitted on the rim is a tire-rim assembly. The tire-rim assembly can include the rim and the tire fitted on the rim.

In the present disclosure, a state where a tire is fitted on a standardized rim, the internal pressure of the tire is adjusted to a standardized internal pressure, and no load is applied to the tire can be referred to as a standardized state.

In the present disclosure, unless otherwise specified, the dimensions and angles of each component of the tire are measured in the standardized state.

The dimensions and angles of each component in a meridian cross-section of the tire, which cannot be measured in a state where the tire is fitted on the standardized rim, are measured in a cross-section (hereinafter, referred to as reference cut plane) of the tire obtained by cutting the tire along a plane including a rotation axis. In this measurement, the distance between right and left beads can be set so as to be equal to the distance between the beads in the tire that is fitted on the standardized rim.

The standardized rim can mean a rim specified in a standard on which the tire is based. The “standard rim” in the JATMA standard, the “Design Rim” in the TRA standard, and the “Measuring Rim” in the ETRTO standard are examples of standardized rims.

The standardized internal pressure can mean an internal pressure specified in the standard on which the tire is based. The “highest air pressure” in the JATMA standard, the “maximum value” recited in “TIRE LOAD LIMITS AT VARIOUS COLD INFLATION PRESSURES” in the TRA standard, and the “INFLATION PRESSURE” in the ETRTO standard are examples of standardized internal pressures.

The standardized load can mean a load specified in the standard on which the tire is based. The “maximum load capacity” in the JATMA standard, the “maximum value” recited in the “TIRE LOAD LIMITS AT VARIOUS COLD INFLATION PRESSURES” in the TRA standard, and the “LOAD CAPACITY” in the ETRTO standard are examples of standardized loads.

In the present disclosure, the “tire designation” can be “tyre designation” specified in JIS D4202 “Automobile tyres—Designation and dimensions.”

In the present disclosure, a tread portion of the tire can be regarded as a portion of the tire that comes into contact with a road surface. A bead portion can be regarded as a portion of the tire that is fitted to a rim. A sidewall portion can be regarded as a portion of the tire that extends between the tread portion and the bead portion. The tire can include a tread portion, a pair of bead portions, and a pair of sidewall portions as portions thereof. A portion of the tread portion at an end thereof can also be referred to as shoulder portion.

### DETAILS OF ONE OR MORE EMBODIMENTS OF PRESENT DISCLOSURE

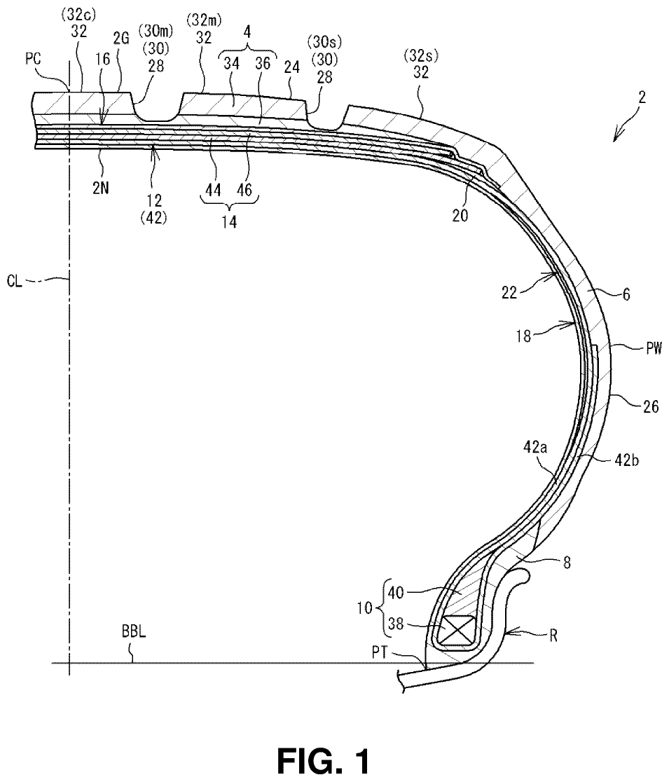

FIG. 1 shows a part of a tire 2 according to an embodiment of the present disclosure. The tire 2 can be a pneumatic tire for a passenger car.

FIG. 1 shows a part of a cross-section (hereinafter, referred to as meridian cross-section) of the tire 2 taken along a plane including the rotation axis of the tire 2. In FIG. 1, the right-left direction is the axial direction of the tire 2, and the up-down direction is the radial direction of the tire 2. The direction perpendicular to the surface of the drawing sheet of FIG. 1 is the circumferential direction of the tire 2. An alternate long and short dash line CL represents the equator plane of the tire 2.

In FIG. 1, the tire 2 can be fitted on a rim R (standardized rim). The interior of the tire 2 can be filled with air to adjust the internal pressure of the tire 2.

In FIG. 1, a solid line BBL extending in the axial direction is a bead base line. The bead base line BBL can be regarded as a line that defines the rim diameter (see JATMA or the like) of the rim R.

In FIG. 1, a position indicated by reference character PC is the point of intersection of an outer surface 2G (specifically, a tread surface described later) of the tire 2 and the equator plane CL. The point of intersection PC is the equator of the tire 2. In the case where a groove is located on the equator plane CL, the equator PC is specified based on a virtual outer surface (virtual tread surface described later) obtained on the assumption that no groove is provided thereon. The equator PC can be regarded as a radially outer end of the tire 2.

In FIG. 1, a position indicated by reference character PW can be regarded as an axially outer end (hereinafter, referred to as outer end PW) of the tire 2. In the case where decorations such as patterns and letters are present on the outer surface 2G of the tire 2, the outer end PW can be specified based on a virtual outer surface obtained on the assumption that the decorations are not present thereon.

The distance in the axial direction, from a first outer end PW to a second outer end PW, obtained in the standardized state is the maximum width of the tire 2. Each outer end PW can also be referred to as maximum width position. The maximum width position can be a position at which the tire 2 has the maximum width. The maximum width obtained in the standardized state can be the cross-sectional width (see JATMA or the like) of the tire 2.

In FIG. 1, a position indicated by reference character PT can be a toe of the tire 2. The toe PT can be regarded as the boundary between the outer surface 2G and an inner surface 2N of the tire 2.

The tire 2 can include a tread 4, a pair of sidewalls 6, a pair of clinches 8, a pair of beads 10, a carcass 12, a belt 14, a band 16, an inner liner 18, a pair of cushions 20, and a pair of insulations 22 as components thereof.

The tread 4 can come into contact with a road surface at a tread surface 24 thereof. The tread 4 can have the tread surface 24 which comes into contact with a road surface. The tread 4 can be located radially outward of the carcass 12 described later. The tread surface 24 can be a part of the outer surface 2G of the tire 2. A side surface 26 can be connected to the tread surface 24. The outer surface 2G of the tire 2 can include the tread surface 24 and a pair of side surfaces 26.

The tread surface 24 can include the equator PC, and each side surface 26 can include the maximum width position PW.

Grooves 28 can be formed on the tread 4. Accordingly, a tread pattern can be formed.

The grooves 28 can include a circumferential groove 30 continuously extending in the circumferential direction. In the tire 2, a plurality of circumferential grooves 30 can be formed on the tread 4 so as to be aligned in the axial direction.

On the tread 4 shown in FIG. 1, four circumferential grooves 30 can be formed, as an example. Among the four circumferential grooves 30, the circumferential groove 30 located on each outermost side in the axial direction can be regarded as a shoulder circumferential groove 30s. The circumferential groove 30 located axially inward of the shoulder circumferential groove 30s can be regarded as a middle circumferential groove 30m.

A plurality of land portions 32 can be formed by forming the circumferential grooves 30 on the tread 4. In the tread 4 shown in FIG. 1, five land portions 32 can be formed, as an example. Among the five land portions 32, the land portion 32 located on each outermost side in the axial direction can be a shoulder land portion 32s. The land portion 32 located axially inward of the shoulder land portion 32s can be a middle land portion 32m. The land portion 32 located axially inward of the middle land portion 32m can be a center land portion 32c. The center land portion 32c can include the equator PC.

The tread 4 can include a cap portion 34 and a base portion 36. The cap portion 34 can include the tread surface 24. The cap portion 34 can be formed from a crosslinked rubber for which wear resistance and grip performance are taken into consideration. The base portion 36 can be located radially inward of the cap portion 34. The entirety of the base portion 36 can be covered with the cap portion 34. The base portion 36 can be formed from a crosslinked rubber that has low heat generation properties.

Each sidewall 6 can be connected to the tread 4. The sidewall 6 can be located radially inward of the tread 4. The sidewall 6 can be located axially outward of the carcass 12. The sidewall 6 can be formed from a crosslinked rubber for which cut resistance is taken into consideration. The sidewall 6 can form a part of the side surface 26.

Each clinch 8 can be located radially inward of the sidewall 6. The clinch 8 can come into contact with the rim R. The clinch 8 can be formed from a crosslinked rubber for which wear resistance is taken into consideration.

Each bead 10 can be located axially inward of the clinch 8. The bead 10 can be located radially inward of the sidewall 6.

The bead 10 can include a core 38 and an apex 40. The core 38 can extend in the circumferential direction. The core 38 can include a steel wire. The apex 40 can be located radially outward of the core 38. The apex 40 can be formed from a crosslinked rubber that has high stiffness.

The carcass 12 can be located inward of the tread 4, the pair of sidewalls 6, and the pair of clinches 8. The carcass 12 can extend on and between the pair of beads 10.

The carcass 12 can include at least one carcass ply 42. The carcass ply 42 can include a relatively large number of carcass cords aligned with each other. These carcass cords can intersect the equator plane CL. The carcass 12 of the tire 2 can have a radial structure. In the tire 2, a cord formed from an organic fiber can be used as each carcass cord, as an example. Examples of the organic fiber can include nylon fibers, rayon fibers, polyester fibers, and aramid fibers.

The carcass ply 42 can include a ply body 42a and a pair of turned-up portions 42b. The ply body 42a can extend between a first bead 10 and a second bead 10. The respective turned-up portions 42b can be connected to the ply body 42a and turned up from the inner side toward the outer side in the axial direction at the respective beads 10.

The belt 14 can be located radially inward of the tread 4. The belt 14 can be stacked on the carcass 12. The belt 14 can be located between the carcass 12 and the tread 4. The above-described equator plane CL can intersect the belt 14 at the center of the axial width of the belt 14, for instance.

In the tire 2, the axial width of the belt 14 can be not less than 85% and not greater than 100% of the width of the tread 4, for instance. According to one or more embodiments, the width of the tread 4 can be twice a reference width HTW described later.

The belt 14 can include an inner layer 44 and an outer layer 46. The inner layer 44 can be located radially outward of the ply body 42a and can be stacked on the ply body 42a. The outer layer 46 can be located radially outward of the inner layer 44 and can be stacked on the inner layer 44.

As shown in FIG. 1, an end of the outer layer 46 can be located axially inward of an end of the inner layer 44. According to one or more embodiments, the outer layer 46 can be narrower than the inner layer 44. The length from the end of the outer layer 46 to the end of the inner layer 44 can be not less than 3 mm and not greater than 10 mm. The above-described axial width of the belt 14 can be represented as the axial width of the wider inner layer 44.

Each of the inner layer 44 and the outer layer 46 can include a relatively large number of belt cords aligned with each other. Each belt cord can be tilted relative to the equator plane CL. The material of the belt cord can be steel, for example.

The band 16 can be stacked on the belt 14 on the inner side of the tread 4. An end of the band 16 can be located axially outward of an end of the belt 14. The length from the end of the belt 14 to the end of the band 16 can be not less than 3 mm and not greater than 7 mm, as an example.

The above-described equator plane CL can intersect the band 16 at the center of the axial width of the band 16. Both ends of the band 16 can be located so as to be opposed to each other across the equator plane CL. According to one or more embodiments, the band 16 can be a full band. The band 16 may be composed of a pair of edge bands disposed so as to be spaced apart from each other in the axial direction with the equator plane CL therebetween and that are each formed so as to cover a portion of the belt 14 at the end thereof. The band 16 may be composed of a full band and a pair of edge bands, according to one or more embodiments of the present disclosure.

The band 16 can include a helically wound band cord. In the band 16, the band cord can extend substantially in the circumferential direction. Specifically, an angle of the band cord with respect to the circumferential direction can be not greater than 5°, as an example. Optionally, the band 16 can have a jointless structure. A cord formed from an organic fiber may be used as the band cord. Examples of the organic fiber can include nylon fibers, rayon fibers, polyester fibers, and aramid fibers.

The inner liner 18 can be located inward of the carcass 12. The inner liner 18 can form the inner surface 2N of the tire 2. The inner liner 18 can be formed from a crosslinked rubber that has a suitable (e.g., excellent) air blocking property. The inner liner 18 can maintain the internal pressure of the tire 2.

Respective cushions 20 can be located so as to be spaced apart from each other in the axial direction. Each cushion 20 can be located between the ends of the belt 14 and the band 16 and the carcass 12. The cushion 20 can be formed from a crosslinked rubber that has low stiffness. Depending on the specifications of the tire 2, the cushions 20 may not necessarily be provided.

Each insulation 22 can be located between the carcass 12 and the inner liner 18. A first end of the insulation 22 can be located axially inward of the end of the belt 14. A second end of the insulation 22 can be located between the maximum width position PW and the bead 10 in the radial direction.

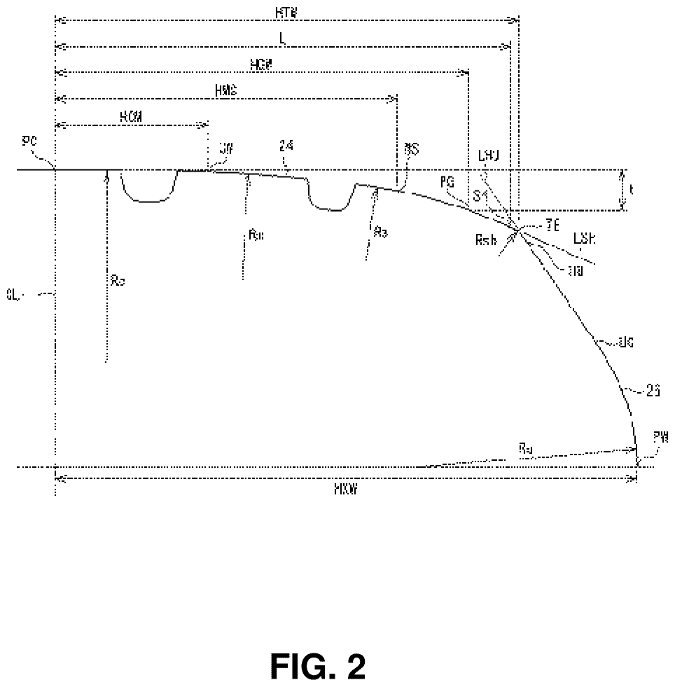

FIG. 2 shows a part of a contour line of the outer surface 2G of the tire 2 in the meridian cross-section according to one or more embodiments of the present disclosure. The contour line of the outer surface 2G can be represented by a virtual outer surface obtained on the assumption that no grooves and no decorations such as patterns and letters are present thereon.

In the present disclosure, the contour line of the outer surface 2G can be obtained by measuring the outer surface shape of the tire 2 in the standardized state, for example, using a displacement sensor.

A contour line of the tread surface 24 in the meridian cross-section can include a plurality of arcs aligned in the axial direction. Specifically, the contour line of the tread surface 24 can be composed of a plurality of arcs aligned in the axial direction.

The plurality of arcs can include a center arc, a pair of middle arcs, a pair of side arcs, and a pair of shoulder arcs.

The center arc can be the arc located at the center in the axial direction among the plurality of arcs. In FIG. 2, an arrow indicated by reference character Rc can represent the radius of the center arc. The center arc can pass through the equator PC. The center of the center arc can be located on the equator plane CL.

Each middle arc can be the arc located axially outward of the center arc. In FIG. 2, an arrow indicated by reference character Rm can represents the radius of the middle arc. The middle arc can have the next largest radius Rm after the radius Rc of the center arc.

Each side arc can be the arc located axially outward of the middle arc. In FIG. 2, an arrow indicated by reference character Rs can represent the radius of the side arc. The side arc can have the next largest radius Rs after the radius Rm of the middle arc.

Each shoulder arc can be the arc located axially outward of the side arc. In FIG. 2, an arrow indicated by reference character Rsh can represent the radius of the shoulder arc. The shoulder arc can have the next largest radius Rsh after the radius Rs of the side arc.

In the tire 2, the center arc can be the arc located at the center in the axial direction among the plurality of arcs. The center arc can have the largest radius Rc among the plurality of arcs included in the contour line of the tread surface 24. The shoulder arc can be the arc located on the outermost side in the axial direction among the plurality of arcs. The shoulder arc can have the smallest radius Rsh among the plurality of arcs included in the contour line of the tread surface 24.

The middle arc can be connected to the center arc. In FIG. 2, a position indicated by reference character CM can be regarded as the boundary between the center arc and the middle arc. The middle arc can be tangent to the center arc at the boundary CM. The boundary CM can be an end of the center arc and can also be a first end of the middle arc.

The side arc can be connected to the middle arc. In FIG. 2, a position indicated by reference character MS can be regarded as the boundary between the middle arc and the side arc. The side arc can be tangent to the middle arc at the boundary MS. The boundary MS can be regarded as a second end of the middle arc and can also be a first end of the side arc.

The shoulder arc can be connected to the side arc. In FIG. 2, a position indicated by reference character SH can be regarded as the boundary between the side arc and the shoulder arc. The shoulder arc can be tangent to the side arc at the boundary SH. The boundary SH can be a second end of the side arc and can also be a first end of the shoulder arc.

According to one or more embodiments of the present disclosure, the contour line of the tread surface 24 of the tire 2 can be composed of seven arcs that include the center arc, the pair of middle arcs, the pair of side arcs, and the pair of shoulder arcs.

In the present disclosure, among arcs that have a center on the equator plane CL and that include the equator PC, an arc that has the largest overlap length with the contour line of the tread surface 24 may be specified as the center arc, an end of this arc may be specified as the boundary CM, and the radius of this arc may be used as the radius Rc of the center arc. Among arcs that have a center on a straight line passing through the boundary CM and the center of the center arc and that include the boundary CM, an arc that has the largest overlap length with the contour line of the tread surface 24 may be specified as the middle arc, the outer end of this arc may be specified as the boundary MS, and the radius of this arc may be used as the radius Rm of the middle arc. Among arcs that have a center on a straight line passing through the boundary MS and the center of the middle arc and that include the boundary MS, an arc that has the largest overlap length with the contour line of the tread surface 24 may be specified as the side arc, the outer end of this arc may be specified as the boundary SH, and the radius of this arc may be used as the radius Rs of the side arc. Among arcs that have a center on a straight line passing through the boundary SH and the center of the side arc and that include the boundary SH, an arc that has the largest overlap length with the contour line of the tread surface 24 may be specified as the shoulder arc, the outer end of this arc may be specified as a boundary HU, and the radius of this arc may be used as the radius Rsh of the shoulder arc.

In the tire 2, a contour line of each side surface 26 can be connected to the shoulder arc. In FIG. 2, a position indicated by reference character HU can be regarded as the boundary between the shoulder arc and the contour line of the side surface 26. The contour line of the side surface 26 can be tangent to the shoulder arc at the boundary HU. The boundary HU can be a second end of the shoulder arc and is also a first end of the contour line of the side surface 26. A second end of the contour line of the side surface 26 can be the toe PT of the tire 2.

In FIG. 2, a straight line indicated by reference character LSH can be regarded as a first tangent line that is tangent to the shoulder arc at the first end SH of the shoulder arc. A straight line indicated by reference character LHU can be regarded as a second tangent line that is tangent to the shoulder arc at the second end HU of the shoulder arc. A position indicated by reference character TE can be regarded as the point of intersection of the first tangent line LSH and the second tangent line LHU. In the present disclosure, the point of intersection TE can be regarded as a tread reference end.

In FIG. 2, a length indicated by reference character HTW can be the distance in the axial direction from the equator plane CL to the tread reference end TE. In the present disclosure, the distance HTW in the axial direction can be the reference width of the tread 4. A length indicated by reference character HXW can be the distance in the axial direction from the equator plane CL to the maximum width position PW. In the present disclosure, the distance HXW in the axial direction can be a reference cross-sectional width. According to one or more embodiments of the present disclosure, the reference cross-sectional width HXW can be the above-described cross-sectional width of the tire 2.

In the tire 2, the ratio (HTW/HXW) of the reference width HTW of the tread 4 to the reference cross-sectional width HXW can be not less than 70% and not greater than 80%, for instance.

In FIG. 2, a length indicated by reference character HCM can be the distance in the axial direction from the equator plane CL to the boundary CM. A length indicated by reference character HMS can be the distance in the axial direction from the equator plane CL to the boundary MS.

In the tire 2, the ratio (HCM/HTW) of the distance HCM in the axial direction to the reference width HTW of the tread 4 can be not less than 0.25 and not greater than 0.35, as an example. The ratio (HMS/HTW) of the distance HMS in the axial direction to the reference width HTW of the tread 4 can be not less than 0.65 and not greater than 0.75, as an example.

The contour line of the side surface 26 can include at least one arc. The contour line of the side surface 26 can include an upper arc. The upper arc can be regarded as an arc that includes the maximum width position PW and that extends from the maximum width position PW toward the tread reference end TE side. The upper arc can be an arc that is convex outward, and the center thereof can be located on a straight line that passes through the maximum width position PW and that extends in the axial direction. In FIG. 2, a position indicated by reference character UG can be regarded as an outer end of the upper arc. In FIG. 2, an arrow indicated by reference character Ru can represent the radius of the upper arc.

In the tire 2, the above-described boundary HU and the outer end UG can be connected by a straight line. The straight line can be tangent to the shoulder arc at the boundary HU and can be tangent to the upper arc at the outer end UG. The position of the boundary HU and the position of the outer end UG may coincide with each other. In this case, the upper arc can be directly connected to the shoulder arc.

According to one or more embodiments, the farther the outer end UG of the upper arc is located from the boundary HU, the more the volume of the rubber at a shoulder portion can be reduced. The reduction of the rubber volume can contribute to reduction of rolling resistance. From this viewpoint, in the contour line of the outer surface 2G, the boundary HU and the outer end UG can be connected by a straight line.

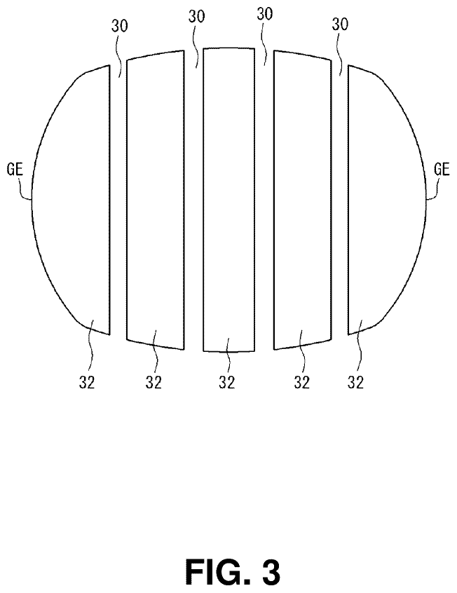

FIG. 3 shows a ground-contact surface shape of the tire 2 according to one or more embodiments of the present disclosure. In FIG. 3, the right-left direction corresponds to the axial direction of the tire 2. The up-down direction corresponds to the circumferential direction of the tire 2.

A ground-contact surface can be obtained, using a tire ground-contact surface shape measuring device, by applying a predetermined load to the tire 2 in the standardized state and bringing the tire 2 into contact with a flat surface. The ground-contact surface shape shown in FIG. 3 can be obtained by tracing the contour of each land portion 32 included in the ground-contact surface. To obtain the ground-contact surface, the tire 2 can be placed such that the axial direction thereof is parallel to a road surface. The above-described load can be applied to the tire 2 in a direction perpendicular to the road surface. In other words, a vertical load can be applied to the tire 2 in a state where the camber angle of the tire 2 is set to 0°.

In FIG. 3, each position indicated by reference character GE can be an axially outer end (also referred to as ground-contact end) of the ground-contact surface. In the present disclosure, each axially outer end GE of a ground-contact surface of the tire 2 obtained by applying a load that can be 80% of the standardized load, to the tire 2 in the standardized state, and bringing the tire 2 into contact with a flat surface, can be regarded as a reference ground-contact end. The position, on the outer surface 2G of the tire 2, corresponding to the reference ground-contact end GE can be regarded as a reference ground-contact position. In FIG. 2, a position indicated by reference character PG can be regarded as the reference ground-contact position.

In FIG. 2, a length indicated by reference character HGW can be the distance in the axial direction from the equator plane CL to the reference ground-contact position PG. In the tire 2, the ratio of the distance HGW in the axial direction to the reference width HTW of the tread 4 can be set in the range of not less than 0.88 and not greater than 0.92, as an example.

In the tire 2, the plurality of arcs included in the contour line of the tread surface 24 can have different radii. The radius of curvature of the contour line of the tread surface 24 can change at the boundaries between the adjacent arcs.

As described above, each shoulder arc can be the arc located on the outermost side in the axial direction among the plurality of arcs included in the contour line of the tread surface 24, and can have the smallest radius Rsh. The contour line of the side surface 26 can be connected to the shoulder arc. In the tire 2, the radius of curvature of the contour line of the tread surface 24 can have the highest rate of change at the boundary SH between the shoulder arc and the side arc. In the present disclosure, the boundary SH between the shoulder arc and the side arc can be regarded as a reference boundary. In FIG. 2, a length indicated by reference character L can be the distance in the axial direction from the equator plane CL to the reference boundary SH.

The contour line of a tread surface may be closely related to the state of contact between a tread and a road surface. Therefore, the present inventors have conducted a thorough study for the relationship between the contour line of the tread surface and generation of compressive strain. As a result, the present inventors have found that the position of a reference boundary with respect to a reference ground-contact end can be involved in generation of compressive strain, specifically, compressive strain tends to be generated at a surface layer portion of a shoulder portion if the reference boundary is located axially inward of the reference ground-contact end position, and thus have completed the present disclosure.

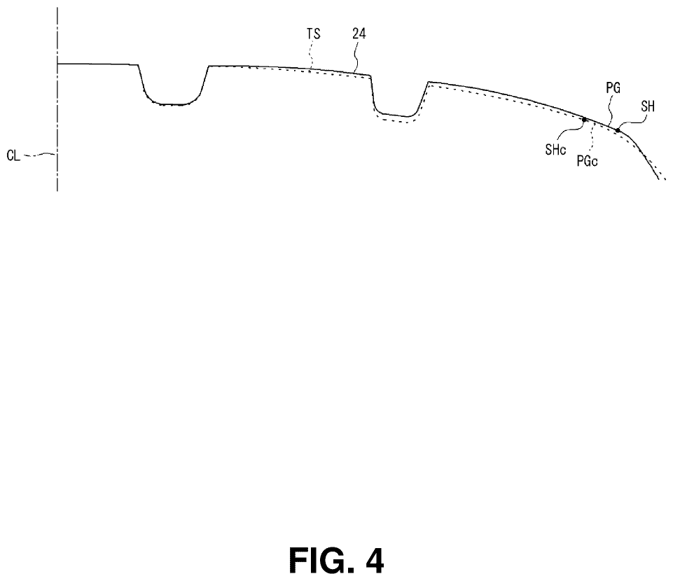

FIG. 4 shows the positional relationship between the reference boundary SH and the reference ground-contact position PG. In FIG. 4, a solid line can represent the contour line of the tread surface 24, and a dotted line can represent the contour line of a conventional tread surface TS. In the contour line of the conventional tread surface TS, a position indicated by reference character SHc can be regarded as a reference boundary in the conventional tread surface TS. A position indicated by reference character PGc can be regarded as a reference ground-contact position in the conventional tread surface TS.

As shown in FIG. 4, in the conventional tread surface TS, the reference boundary SHc can be located axially inward of the reference ground-contact position PGc. On the other hand, in the tread surface 24 of the tire 2, the reference boundary SH can be located axially outward of the reference ground-contact position PG. In the tread surface 24, the reference boundary SH at which the change in curvature of the contour line is relatively large may not be included in the ground-contact surface. In the tire 2, generation of compressive strain at the surface layer portion of the shoulder portion, which is confirmed in a conventional tire, can be suppressed.

If the reference boundary SH is located axially outward away from the reference ground-contact position PG, there may be a concern that the thickness of the tread 4 at the shoulder portion may increase. The increase in the thickness of the tread 4 can increase rolling resistance. Thus, in this case, the rolling resistance reduction effect brought about by suppressing generation of compressive strain may be canceled out.

However, in the tire 2, the ratio (L/HTW) of the distance L in the axial direction from the equator plane CL to the reference boundary SH to the distance HTW in the axial direction from the equator plane CL to the tread reference end TE can be not less than 0.94 and not greater than 0.98.

Since the ratio (L/HTW) can be not greater than 0.98, the reference boundary SH can be located without being excessively far from the reference ground-contact position PG. The interval between the reference boundary SH and the reference ground-contact position PG can be appropriately maintained, so that the tread 4 at the shoulder portion can be formed with an appropriate thickness. In the tire 2, an increase in rolling resistance due to an increase in thickness can be suppressed. In the tire 2, the rolling resistance reduction effect brought about by suppressing generation of compressive strain can be sufficiently exhibited. From this viewpoint, the ratio (L/HTW) can be not greater than 0.97, for instance.

Since the ratio (L/HTW) can be not less than 0.94, the fact that the reference boundary SH can be located axially outward of the reference ground-contact position PG can effectively contribute to suppressing generation of compressive strain. In the tire 2, rolling resistance caused by compressive strain can be reduced. From this viewpoint, the ratio (L/HTW) can be not less than 0.95, for instance.

According to one or more embodiments of the present disclosure, the tire 2, the reference boundary SH can be located axially outward of the reference ground-contact position PG, and the ratio (L/HTW) of the distance L in the axial direction from the equator plane CL to the reference boundary SH to the distance HTW in the axial direction from the equator plane CL to the tread reference end TE can be not less than 0.94 and not greater than 0.98.

In the tire 2 according to one or more embodiments of the present disclosure, generation of compressive strain can be suppressed, and the tread 4 at the shoulder portion can be formed with an appropriate thickness. The tire 2 can achieve reduction of rolling resistance.

As described above, in the tread 4 of the tire 2, the cap portion 34 can be formed from a crosslinked rubber for which wear resistance and grip performance are taken into consideration. In the tire 2, it may not be necessary to replace the crosslinked rubber of the cap portion 34 with a low loss rubber in order to reduce rolling resistance. The tire 2 can achieve reduction of rolling resistance without decreasing grip performance on a wet road surface.

In FIG. 2, a length indicated by reference character t can be regarded as the distance in the radial direction from the equator PC to the reference ground-contact position PG.

In the tire 2, the ratio (t/HTW) of the distance t in the radial direction from the equator PC to the reference ground-contact position PG to the distance HTW in the axial direction from the equator plane CL to the tread reference end TE can be not less than 0.06 and not greater than 0.15, as an example.

When the ratio (t/HTW) is set to be not less than 0.06, the tread surface 24 may not become excessively flat, and the tread 4 at the shoulder portion can be formed with an appropriate thickness in the tire 2. A local increase in ground-contact pressure can be suppressed, so that occurrence of uneven wear is suppressed. In the tire 2, good uneven wear resistance can be maintained. From this viewpoint, the ratio (t/HTW) can be not less than 0.10, for instance.

When the ratio (t/HTW) is set to be not greater than 0.15, generation of compressive strain can be effectively suppressed. The tire 2 can achieve further reduction of rolling resistance. From this viewpoint, the ratio (t/HTW) can be not greater than 0.12, for instance.

In the tire 2, the ratio (Rm/Rs) of the radius Rm of the middle arc to the radius Rs of the side arc can be not less than 2.1 and not greater than 2.7, for instance.

When the ratio (Rm/Rs) is set to be not less than 2.1, generation of compressive strain can be effectively suppressed. The tire 2 can achieve further reduction of rolling resistance. From this viewpoint, the ratio (Rm/Rs) can be not less than 2.3.

When the ratio (Rm/Rs) is set to be not greater than 2.7, slip of the tread surface 24 against a road surface can be suppressed, and the tread 4 at the shoulder portion is formed with an appropriate thickness. In the tire 2, good uneven wear resistance can be maintained. From this viewpoint, the ratio (Rm/Rs) can be not greater than 2.5, for instance.

In the tire 2, the ratio (Rc/Rm) of the radius Rc of the center arc to the radius Rm of the middle arc can be not less than 4.0 and not greater than 5.5, for instance.

When the ratio (Rc/Rm) is set to be not less than 4.0, generation of compressive strain can be effectively suppressed. The tire 2 can achieve further reduction of rolling resistance. From this viewpoint, the ratio (Rc/Rm) can be not less than 4.2, for instance.

When the ratio (Rc/Rm) is set to be not greater than 5.5, slip of the tread surface 24 against a road surface can be suppressed, and the tread 4 at the shoulder portion can be formed with an appropriate thickness. In the tire 2, good uneven wear resistance can be maintained. From this viewpoint, the ratio (Rm/Rs) can be not greater than 5.3, for instance.

In the tire 2, the ratio (Rs/Rsh) of the radius Rs of the side arc to the radius Rsh of the shoulder arc can be not less than 10 and not greater than 20, for instance.

When the ratio (Rs/Rsh) is set to be not less than 10, generation of compressive strain can be effectively suppressed. The tire 2 can achieve further reduction of rolling resistance. From this viewpoint, the ratio (Rs/Rsh) can be not less than 13, for instance.

When the ratio (Rs/Rsh) is set to be not greater than 20, slip of the tread surface 24 against a road surface can be suppressed, and the tread 4 at the shoulder portion can be formed with an appropriate thickness. In the tire 2, good uneven wear resistance can be maintained. From this viewpoint, the ratio (Rs/Rsh) can be not greater than 17, for instance.

As described above, according to the present disclosure, a tire that can achieve reduction of rolling resistance without decreasing grip performance on a wet road surface can be obtained.

### EXAMPLES

Hereinafter, the present disclosure will be described in further detail by means of examples, etc., but the present disclosure is not limited to these examples.

### Example 1

A pneumatic tire for a passenger car (tire size=205/55R19) having the basic structure shown in FIG. 1 was obtained.

By adjusting the contour line of the tread surface, the ratio (L/HTW), the ratio (t/HTW), and the ratio (Rm/Rs) were set as shown in Table 1 below.

The ratio (HGW/HTW) of the distance HGW in the axial direction from the equator plane to the reference ground-contact position PG to the reference width HTW of the tread was 0.88. In Example 1, the reference boundary SH was located axially outward of the reference ground-contact position PG.

The cap portion of the tread was formed from a crosslinked rubber for which grip performance on a wet road surface was taken into consideration, instead of a low loss rubber.

### Comparative Example 1

A tire of Comparative Example 1 is a conventional tire. The ratio (L/HTW), the ratio (t/HTW), and the ratio (Rm/Rs) in Comparative Example 1 are as shown in Table 1 below. The ratio (HGW/HTW) of the distance HGW in the axial direction from the equator plane to the reference ground-contact position PGc to the reference width HTW of the tread was 0.88. In Comparative Example 1, the reference boundary SHc was located axially inward of the reference ground-contact position PGc. The basic structure of Comparative Example 1 is the same as that of Example 1.

### Examples 2 to 7 and Comparative Examples 2 and 3

By adjusting the contour line of the tread surface, the ratio (L/HTW), the ratio (t/HTW), and the ratio (Rm/Rs) were set as shown in Table 1 below, and tires of Examples 2 to 7 and Comparative Examples 2 and 3 were obtained. In each of these tires, the ratio (HGW/HTW) was 0.88. The basic structures of Examples 2 to 7 and Comparative Examples 2 and 3 are the same as that of Example 1.

[Rolling Resistance]

Using a rolling resistance testing machine, a rolling resistance coefficient (RRC) was measured when a test tire ran on a drum at a speed of 80 km/h under the following conditions. The results are shown as indexes in the cells for “RRC” in Tables 1 and 2 below with the result of Comparative Example 1 being regarded as 100. The higher the value is, the lower the rolling resistance of the tire is.
Rim 16×6.5J
Internal pressure: 210 kPa
Vertical load: 4.82 kN

[Uneven Wear Resistance]

A test tire was fitted onto a rim (size=16×7.0J) and inflated with air to adjust the internal pressure thereof to 250 kPa. The tire was mounted to a wear energy measuring device. A camber angle was set to 0°, a slip angle was set to 0°, and the wear energy of the tire was measured. A ratio (Ec/Es) was obtained as an index of uneven wear resistance from wear energy Ec at the equator plane and wear energy Es at the ground-contact end. The results are shown as indexes in the cells for “Uneven wear resistance” in Tables 1 and 2 below with the result of Comparative Example 1 being regarded as 100. The lower the value is, the better the uneven wear resistance is.

TABLE 1

| | Comparative | Comparative | Example | Example | Example | Comparative |
|---|---|---|---|---|---|---|
| | Example 1 | Example 2 | 2 | 1 | 3 | Example 3 |
| L/HTW [—] | 0.86 | 0.93 | 0.94 | 0.97 | 0.98 | 0.99 |
| t/HTW [—] | 0.10 | 0.12 | 0.12 | 0.12 | 0.12 | 0.12 |
| Rm/Rs [—] | 2.0 | 2.5 | 2.5 | 2.5 | 2.5 | 2.5 |
| RRC | 100 | 100 | 101 | 105 | 103 | 100 |
| Uneven wear | 100 | 100 | 100 | 100 | 100 | 100 |
| resistance | | | | | | |

TABLE 2

| | Example | Example | Example | Example |
|---|---|---|---|---|
| | 4 | 5 | 6 | 7 |
| L/HTW [—] | 0.97 | 0.97 | 0.97 | 0.97 |
| t/HTW [—] | 0.1 | 0.15 | 0.12 | 0.12 |
| Rm/Rs [—] | 2.5 | 2.5 | 2.1 | 2.7 |
| RRC | 102 | 102 | 103 | 101 |
| Uneven | 100 | 100 | 100 | 100 |
| wear | | | | |
| resistance | | | | |

As shown in Tables 1 and 2, in each Example, reduction of rolling resistance is achieved without using a low loss rubber for the cap portion. That is, in each Example shown in Tables 1 and 2, reduction of rolling resistance is achieved without decreasing grip performance on a wet road surface. From the evaluation results, advantages of the present disclosure are clear.

The above-described technology capable of reducing rolling resistance without using a low loss rubber can also be applied to various tires.

### OUTLINE OF EMBODIMENTS OF PRESENT DISCLOSURE

Hereinafter, the outlines of embodiments of the present disclosure are listed and described.

[Configuration 1]

A tire according to an aspect of the present disclosure can be a tire including a pair of beads, a carcass extending on and between the pair of beads, a pair of sidewalls located axially outward of the carcass, a tread located radially outward of the carcass, and a belt located between the carcass and the tread, wherein: an outer surface of the tire includes a tread surface configured to come into contact with a road surface, and a pair of side surfaces connected to the tread surface; the tread surface includes an equator that is a point of intersection with an equator plane; each of the side surfaces includes a maximum width position at which the tire has a maximum width; in a meridian cross-section of the tire, a contour line of the tread surface includes a plurality of arcs aligned in an axial direction; the plurality of arcs include a center arc passing through the equator, a pair of middle arcs connected to the center arc, a pair of side arcs connected to the middle arcs, respectively, and a pair of shoulder arcs connected to the side arcs, respectively; contour lines of the pair of side surfaces are connected to the pair of shoulder arcs, respectively; a point of intersection of a tangent line tangent to the shoulder arc at a first end of the shoulder arc and a tangent line tangent to the shoulder arc at a second end of the shoulder arc is a tread reference end; a ground-contact end obtained by fitting the tire onto a standardized rim, adjusting an internal pressure of the tire to a standardized internal pressure, applying a load that is 80% of a standardized load, to the tire, and bringing the tire into contact with a flat surface is a reference ground-contact end; a position, on the outer surface of the tire, corresponding to the reference ground-contact end is a reference ground-contact position; a boundary between the shoulder arc and the side arc is a reference boundary; the reference boundary is located axially outward of the reference ground-contact position; and a ratio of a distance in the axial direction from the equator plane to the reference boundary to a distance in the axial direction from the equator plane to the tread reference end is not less than 0.94 and not greater than 0.98, for instance.

By shaping the tire as described above, flattening of the portion, of the tread surface, that comes into contact with a road surface can be promoted. Accordingly, generation of compressive strain, which is confirmed at a shoulder portion of a conventional tire, can be suppressed. The reduction of compressive strain can contribute to reduction of rolling resistance.

Even if a rubber for which grip performance on a wet road surface is taken into consideration is used for the tread, the tire can achieve reduction of rolling resistance without replacing this rubber with a low loss rubber. The tire can achieve reduction of rolling resistance without decreasing grip performance on a wet road surface.

[Configuration 2]

Preferably, in the tire described in [Configuration 1] above, a ratio of a distance in a radial direction from the equator to the reference ground-contact position to the distance in the axial direction from the equator plane to the tread reference end can be not less than 0.06 and not greater than 0.15, for instance.

In the tire of [Configuration 1] described above, flattening of the tread surface can be promoted. If the tread surface becomes excessively flat, the thickness of the tread at a shoulder portion can increase. In this case, there may be a concern that ground-contact pressure near the ground-contact end may locally increase and uneven wear may occur. There may also be a concern that even though reduction of rolling resistance is enabled by the reduction of compressive strain, the thick tread may cause an increase in rolling resistance.

However, by shaping the tire as in [Configuration 2], the tread surface may not become excessively flat, and the tread at the shoulder portion can be formed with an appropriate thickness. The tire can achieve reduction of rolling resistance while maintaining good uneven wear resistance. Even if a rubber for which grip performance on a wet road surface is taken into consideration is used for the tread, it may not be necessary to replace this rubber with a low loss rubber. The tire can achieve reduction of rolling resistance without decreasing grip performance on a wet road surface, while maintaining good uneven wear resistance.

[Configuration 3]

Preferably, in the tire described in [Configuration 1] or [Configuration 2] above, a ratio of a radius of the middle arc to a radius of the side arc can be not less than 2.1 and not greater than 2.7, for instance.

Even in a flat tread surface that enables reduction of compressive strain, if a rate of change of the radius of curvature of the contour line of the tread surface is relatively large at the boundary between a middle arc and a side arc, there may be a concern that the tread surface may be likely to slip against a road surface at a ground-contact surface thereof. Slip of the tread surface against a road surface can promote occurrence of uneven wear. On the other hand, if the rate of change of the radius of curvature is relatively small, the thickness of the tread at the shoulder portion can increase. Thus, in this case as well, occurrence of uneven wear may be promoted.

However, by shaping the tire as in [Configuration 3], slip of the tread surface against a road surface can be suppressed, and the tread at the shoulder portion can be formed with an appropriate thickness in the tire. The tire can achieve reduction of rolling resistance while maintaining good uneven wear resistance. Even if a rubber for which grip performance on a wet road surface is taken into consideration is used for the tread, it may not be necessary to replace this rubber with a low loss rubber. The tire can achieve reduction of rolling resistance without decreasing grip performance on a wet road surface, while maintaining good uneven wear resistance.

The present disclosure has been made in view of such circumstances. An object of the present disclosure, among one or more objects, can be to provide a tire that can achieve reduction of rolling resistance without decreasing grip performance on a wet road surface.

What is claimed is:

1. A tire comprising:
a pair of beads;
a carcass extending on and between the pair of beads;
a pair of sidewalls axially outward of the carcass;
a tread radially outward of the carcass; and
a belt between the carcass and the tread, wherein
an outer surface of the tire includes a tread surface configured to come into contact with a road surface, and a pair of side surfaces connected to the tread surface,
the tread surface includes an equator that is a point of intersection with an equator plane,
each of the side surfaces includes a maximum width position at which the tire has a maximum width,
in a meridian cross-section of the tire, a contour line of the tread surface includes a plurality of arcs aligned in an axial direction,
the plurality of arcs include a center arc passing through the equator, a pair of middle arcs connected to the center arc, a pair of side arcs connected to the middle arcs, respectively, and a pair of shoulder arcs connected to the side arcs, respectively,
contour lines of the pair of side surfaces are connected to the pair of shoulder arcs, respectively,
a point of intersection of a tangent line tangent to the shoulder arc at a first end of the shoulder arc and a tangent line tangent to the shoulder arc at a second end of the shoulder arc is a tread reference end,
a ground-contact end obtained by fitting the tire onto a standardized rim, adjusting an internal pressure of the tire to a standardized internal pressure, applying a load that is 80% of a standardized load, to the tire, and bringing the tire into contact with a flat surface is a reference ground-contact end,
a position, on the outer surface of the tire, corresponding to the reference ground-contact end is a reference ground-contact position,
a boundary between the shoulder arc and the side arc is a reference boundary,
the reference boundary is located axially outward of the reference ground-contact position, and
a ratio of a distance in the axial direction from the equator plane to the reference boundary to a distance in the axial direction from the equator plane to the tread reference end is not less than 0.94 and not greater than 0.98.

2. The tire according to claim 1, wherein a ratio of a distance in a radial direction from the equator to the reference ground-contact position to the distance in the axial direction from the equator plane to the tread reference end is not less than 0.06 and not greater than 0.15.

3. The tire according to claim 2, wherein the ratio of the distance in the radial direction from the equator to the reference ground-contact position to the distance in the axial direction from the equator plane to the tread reference end is not less than 0.10 and not greater than 0.12.

4. The tire according to claim 1, wherein a ratio of a radius of the middle arc to a radius of the side arc is not less than 2.1 and not greater than 2.7.

5. The tire according to claim 4, wherein the ratio of the radius of the middle arc to the radius of the side arc is not less than 2.3 and not greater than 2.5.

6. The tire according to claim 4, wherein a ratio of a distance in a radial direction from the equator to the reference ground-contact position to the distance in the axial direction from the equator plane to the tread reference end is not less than 0.06 and not greater than 0.15.

7. The tire according to claim 1,
wherein each said bead is axially inward of a corresponding clinch, and
wherein each said bead is radially inward of a corresponding one of the sidewalls.

8. The tire according to claim 1, wherein a first radius of the center arc is greater than a second radius of each of the side arcs, the second radius of the side arcs is greater than a third radius of each of the side arcs, and the third radius of the side arcs is greater than a fourth radius of each of the shoulder arcs.

9. The tire according to claim 1, wherein radially outward of the reference boundary does not form part of a ground contact surface of the tire.

10. The tire according to claim 1, wherein a cap portion of the tread is formed from a crosslinked rubber for which wear resistance and grip performance are taken into consideration.

11. The tire according to claim 1, wherein a ratio of a length from the equator plane to the reference ground-contact position to the distance in the axial direction from the equator plane to the tread reference end is not less than 0.06 and not greater than 0.15.

12. The tire according to claim 11, wherein the ratio of the length from the equator plane to the reference ground-contact position to the distance in the axial direction from the equator plane to the tread reference end is not less than 0.10 and not greater than 0.12.

13. The tire according to claim 1, wherein a ratio of a radius of the center arc to a radius of the middle are is not less 4.0 and not greater than 5.5.

14. The tire according to claim 13, wherein the ratio of the radius of the center arc to the radius of the middle are is not less than 4.2 and not greater than 5.3.

15. The tire according to claim 1, wherein a ratio of a radius of the side arc to a radius of the shoulder arc is not less than 10 and not greater than 20.

16. The tire according to claim 15, wherein the ratio of a radius of the side arc to the radius of the shoulder arc is not less than 13 and not greater than 17.

17. The tire according to claim 1,
wherein the tire consists of four circumferential grooves, and
wherein the tire consists of five landing portions.

18. The tire according to claim 1,
wherein a ratio of a length from the equator plane to the reference ground-contact position to the distance in the axial direction from the equator plane to the tread reference end is not less than 0.06 and not greater than 0.15,
wherein a ratio of a radius of the center arc to a radius of the middle are is not less 4.0 and not greater than 5.5, and
wherein a ratio of a radius of the side arc to a radius of the shoulder arc is not less than 10 and not greater than 20.

19. The tire according to claim 18,
wherein the ratio of the length from the equator plane to the reference ground-contact position to the distance in the axial direction from the equator plane to the tread reference end is not less than 0.10 and not greater than 0.12,
wherein the ratio of the radius of the center arc to the radius of the middle are is not less than 4.2 and not greater than 5.3, and
wherein the ratio of a radius of the side arc to the radius of the shoulder arc is not less than 13 and not greater than 17.

20. The tire according to claim 18,
wherein a ratio of a distance in a radial direction from the equator to the reference ground-contact position to the distance in the axial direction from the equator plane to the tread reference end is not less than 0.06 and not greater than 0.15, and/or
wherein a ratio of a radius of the middle arc to a radius of the side arc is not less than 2.1 and not greater than 2.7.
